(19) United States
(12) Patent Application Publication
(10) Pub. No.: US 2025/0185051 A1
(43) Pub. Date: Jun. 5, 2025

(54) BANDWIDTH OF DATA UNIT IN WIRELESS LAN SYSTEM

(71) Applicant: LG ELECTRONICS INC., Seoul (KR)

(72) Inventors: Dongguk LIM, Seoul (KR); Jinyoung CHUN, Seoul (KR); Jinsoo CHOI, Seoul (KR); Eunsung PARK, Seoul (KR); Insik JUNG, Seoul (KR)

(73) Assignee: LG ELECTRONICS INC., Seoul (KR)

(21) Appl. No.: 18/842,352

(22) PCT Filed: Mar. 2, 2023
(86) PCT No.: PCT/KR2023/002840

§ 371 Date: Aug. 28, 2024

(30) Foreign Application Priority Data
Mar. 2, 2022 (KR) 10-2022-0027032
May 24, 2022 (KR) 10-2022-0063659

(51) Int. Cl. H04W 72/53; H04L 5/00; H04W 72/0453; H04W 84/12

(52) U.S. Cl. CPC H04W 72/53; H04L 5/0044; H04W 72/0453; H04W 84/12

(57) ABSTRACT

The present specification proposes a method and a device for indicating a bandwidth (BW) of a non-high throughput (HT) PPDU or a non-HT dup PPDU. The bandwidth proposed in the present specification may be at least one band among 320 MHz, 480 MHz, 560 MHz, and/or 640 MHz. For example, some bits of a service field having a 16-bit length, included in a data field, may be used to indicate 320 MHz, 480 MHz, 560 MHz, and/or 640 MHz, described above. The present specification proposes a combination of various bits indicating 320 MHz, 480 MHz, 560 MHz, and/or 640 MHz.

### CROSS-REFERENCE TO RELATED APPLICATION(S)

This application is the National Stage filing under 35 U.S.C. 371 of International Application No. PCT/KR2023/002840, filed on Mar. 2, 2023, which claims the benefit of earlier filing date and right of priority to Korean Application Nos. 10-2022-0027032, filed on Mar. 2, 2022, and 10-2022-0063659, filed on May 24, 2022, the contents of which are all incorporated by reference herein in their entirety.

### TECHNICAL FIELD

The present disclosure relates to wireless communication systems. More specifically, it relates to technical features for transmitting and receiving bandwidth-directed packets in a wireless local area network (WLAN) system.

### BACKGROUND

A wireless local area network (WLAN) has been enhanced in various ways. For example, the IEEE 802.11ax standard proposed an enhanced communication environment using orthogonal frequency division multiple access (OFDMA) and downlink multi-user multiple input multiple output (DL MU MIMO) techniques.

For example, the IEEE 802.11be standard or Extreme high throughput (EHT) may use newly proposed increased bandwidth, improved PHY layer protocol data unit (PPDU) structure, improved sequencing, hybrid automatic repeat request (HARQ) techniques, etc.

This specification proposes new technical features that improve upon conventional WLAN specifications. The technical features proposed in this specification may be enhancements to the technical features of IEEE 802.11ax and/or 802.11be.

### SUMMARY

The present disclosure may relate to transmitting signals based on a non-HT (High Throughput) PPDU (or non-HT dup PPDU, non-HT Duplicate PPDU). For example, the present disclosure may relate to techniques/methods/apparatus for indicating the bandwidth (BW) of the non-HT PPDU.

The present disclosure proposes various technical features. The various technical features of the present disclosure can be applied to various types of devices and methods.

For example, a station of the present disclosure may configure a non-HT (High Throughput) PPDU (Physical Protocol Data Unit) comprising a preamble and a data field.

The data field may include a service field, and the service field may include bits B0 through B15.

The non-HT PPDU may be duplicated in frequency domain.

The service field may comprise information related to the total bandwidth of the duplicated non-HT PPDU.

The value of bit B8 of the service field may relate to whether the total bandwidth exceeds 320 MHz.

The STA may transmit the duplicated non-HT PPDU.

The present disclosure proposes techniques/methods/apparatus for directing bandwidth (BW) when transmitting signals based on a non-HT (High Throughput) PPDU (or non-HT dup PPDU, non-HT Duplicate PPDU). For example, when transmitting (or receiving) a non-HT PPDU over an increased bandwidth (e.g., 480/560/640 MHz) compared to conventional wireless LAN (WLAN) specifications, a new technique for indicating such bandwidth is needed. This disclosure presents an efficient technique for directing the bandwidth of non-HT PPDUs. By doing so, the present disclosure may improve the performance of a wireless communication system or a WLAN system.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates an example of a PPDU used in an IEEE standard.

FIG. 4 illustrates a layout of resource units (RUS) used in a band of 20 MHz.

FIG. 5 illustrates a layout of RUs used in a band of 40 MHz.

FIG. 6 illustrates a layout of RUs used in a band of 80 MHz.

FIG. 7 illustrates a structure of an HE-SIG-B field.

FIG. 8 illustrates an example in which a plurality of user STAs are allocated to the same RU through a MU-MIMO scheme.

FIG. 9 illustrates an operation based on UL-MU.

FIG. 10 illustrates an example of a channel used/supported/defined within a 2.4 GHz band.

FIG. 11 illustrates an example of a channel used/supported/defined within a 5 GHz band.

FIG. 12 illustrates an example of a channel used/supported/defined within a 6 GHz band.

FIG. 13 illustrates an example of a PPDU used in the present specification.

FIG. 14 illustrates an example of a modified transmission device and/or receiving device of the present specification.

FIG. 15 shows an example of a service field included in a Non-HT PPDU.

FIG. 16 illustrates an example of a data scrambler.

FIG. 17 is a procedural flow diagram describing actions performed at the transmitting STA.

FIG. 18 is a procedural flow diagram illustrating actions performed in a receive STA.

### DESCRIPTION OF EXEMPLARY EMBODIMENTS

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may mean that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3rd generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

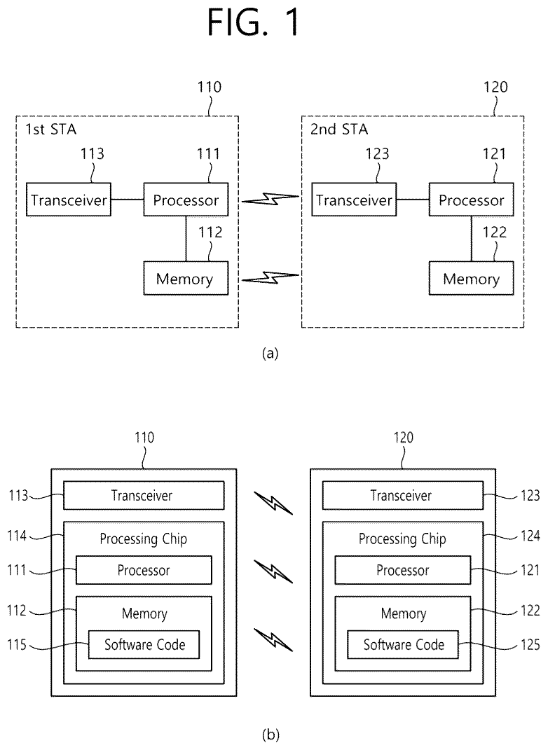

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP. In the present specification, the AP may be indicated as an AP STA.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance an operation of may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an AP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

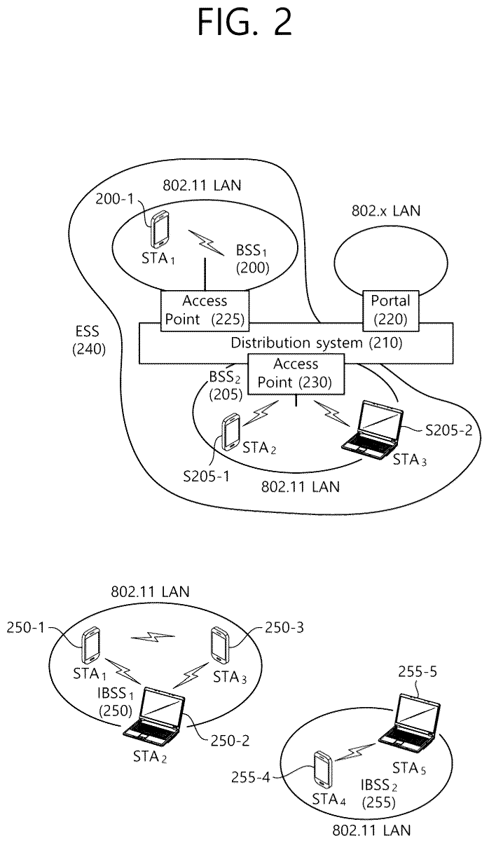

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

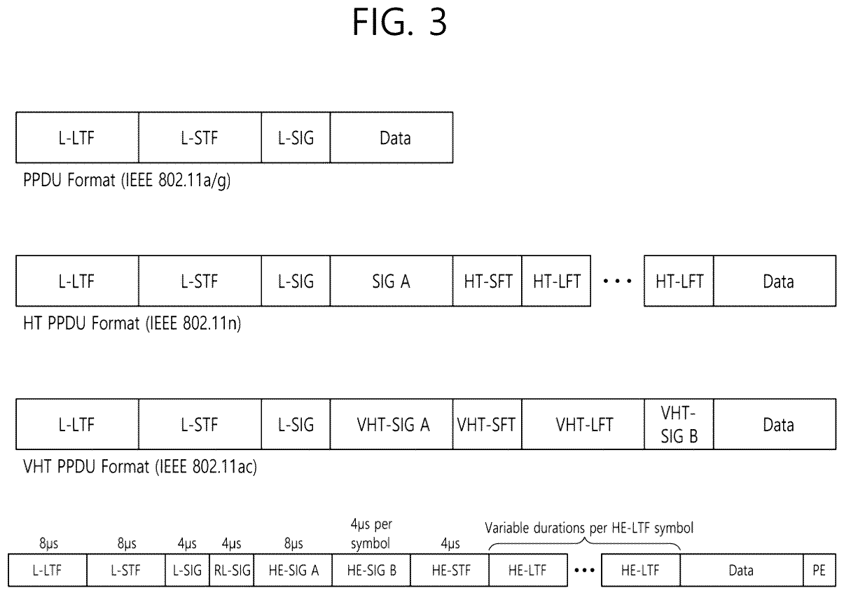

FIG. 3 illustrates an example of a PPDU used in an IEEE standard.

As illustrated in FIG. 3, various types of PHY protocol data units (PPDUs) are used in IEEE a/g/n/ac standards. Specifically, an LTF and a STF include a training signal, a SIG-A and a SIG-B include control information for a receiving STA, and a data field includes user data corresponding to a PSDU (MAC PDU/aggregated MAC PDU).

FIG. 3 also includes an example of an HE PPDU according to IEEE 802.11ax. The HE PPDU according to FIG. 3 is an illustrative PPDU for multiple users. An HE-SIG-B may be included only in a PPDU for multiple users, and an HE-SIG-B may be omitted in a PPDU for a single user.

As illustrated in FIG. 3, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, a MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

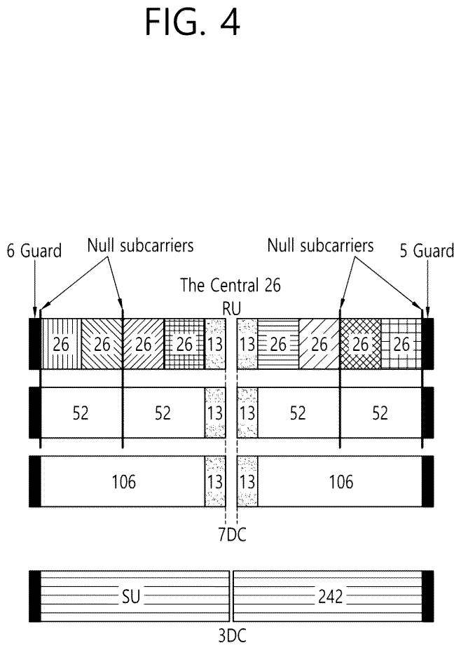

FIG. 4 illustrates a layout of resource units (RUs) used in a band of 20 MHz.

As illustrated in FIG. 4, resource units (RUs) corresponding to different numbers of tones (i.e., subcarriers) may be used to form some fields of an HE-PPDU. For example, resources may be allocated in illustrated RUs for an HE-STF, an HE-LTF, and a data field.

As illustrated in the uppermost part of FIG. 4, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

The layout of the RUs in FIG. 4 may be used not only for a multiple users (MUs) but also for a single user (SU), in which case one 242-unit may be used and three DC tones may be inserted as illustrated in the lowermost part of FIG. 4.

Although FIG. 4 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones).

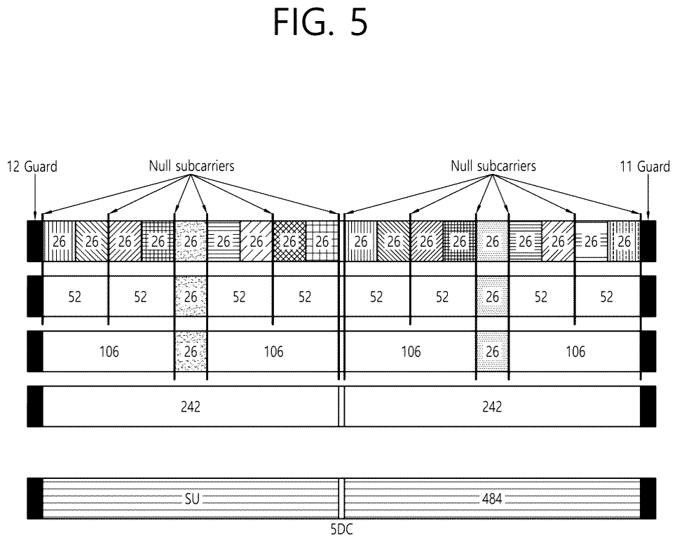

FIG. 5 illustrates a layout of RUs used in a band of 40 MHz.

Similar to FIG. 4 in which RUs having various sizes are used, a 26-RU, a 52-RU, a 106-RU, a 242-RU, a 484-RU, and the like may be used in an example of FIG. 5. Further, five DC tones may be inserted in a center frequency, 12 tones may be used for a guard band in the leftmost band of the 40 MHz band, and 11 tones may be used for a guard band in the rightmost band of the 40 MHz band.

As illustrated, when the layout of the RUs is used for a single user, a 484-RU may be used. The specific number of RUs may be changed similar to FIG. 5.

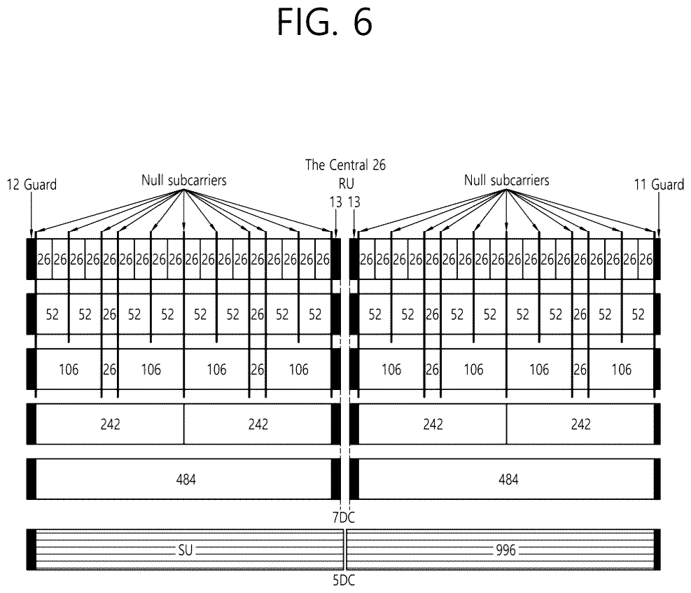

FIG. 6 illustrates a layout of RUs used in a band of 80 MHz.

Similar to FIG. 4 and FIG. 5 in which RUs having various sizes are used, a 26-RU, a 52-RU, a 106-RU, a 242-RU, a 484-RU, a 996-RU, and the like may be used in an example of FIG. 6. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

As illustrated, when the layout of the RUs is used for a single user, a 996-RU may be used, in which case five DC tones may be inserted.

The RU described in the present specification may be used in uplink (UL) communication and downlink (DL) communication. For example, when UL-MU communication which is solicited by a trigger frame is performed, a transmitting STA (e.g., AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

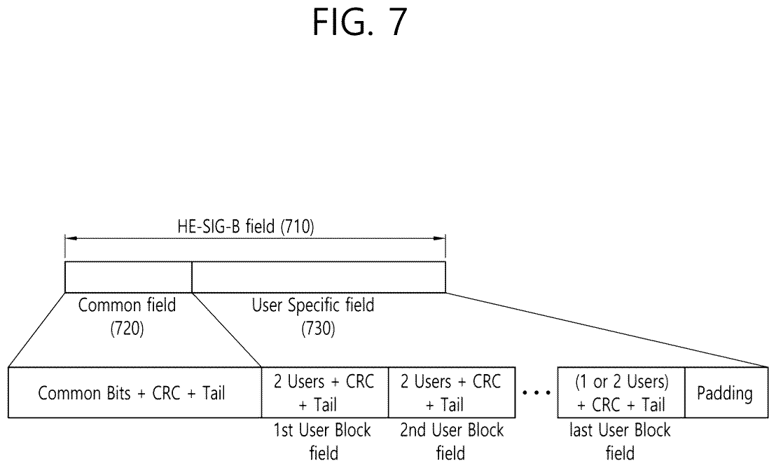

FIG. 7 illustrates a structure of an HE-SIG-B field.

As illustrated, an HE-SIG-B field 710 includes a common field 720 and a user-specific field 730. The common field 720 may include information commonly applied to all users (i.e., user STAs) which receive SIG-B. The user-specific field 730 may be called a user-specific control field. When the SIG-B is transferred to a plurality of users, the user-specific field 730 may be applied only any one of the plurality of users.

As illustrated, the common field 720 and the user-specific field 730 may be separately encoded.

The common field 720 may include RU allocation information of N*8 bits. For example, the RU allocation information may include information related to a location of an RU. For example, when a 20 MHz channel is used as shown in FIG. 4, the RU allocation information may include information related to a specific frequency band to which a specific RU (26-RU/52-RU/106-RU) is arranged.

An example of a case in which the RU allocation information consists of 8 bits is as follows.

TABLE 1

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |
| 00000000 | 26 | 26 | 26 | 26 | 26 | 26 | 26 | 26 | 26 | 1 |

| | | | | | | | | | |
|---|---|---|---|---|---|---|---|---|---|
| 00000001 | 26 | 26 | 26 | 26 | 26 | 26 | 26 | 52 | 1 |

| | | | | | | | | | |
|---|---|---|---|---|---|---|---|---|---|
| 00000010 | 26 | 26 | 26 | 26 | 26 | 52 | 26 | 26 | 1 |

| | | | | | | | | |
|---|---|---|---|---|---|---|---|---|
| 00000011 | 26 | 26 | 26 | 26 | 26 | 52 | 52 | 1 |

| | | | | | | | | | |
|---|---|---|---|---|---|---|---|---|---|
| 00000100 | 26 | 26 | 52 | 26 | 26 | 26 | 26 | 26 | 1 |

| | | | | | | | | |
|---|---|---|---|---|---|---|---|---|
| 00000101 | 26 | 26 | 52 | 26 | 26 | 26 | 52 | 1 |

| | | | | | | | | |
|---|---|---|---|---|---|---|---|---|
| 00000110 | 26 | 26 | 52 | 26 | 52 | 26 | 26 | 1 |

| | | | | | | | |
|---|---|---|---|---|---|---|---|
| 00000111 | 26 | 26 | 52 | 26 | 52 | 52 | 1 |

| | | | | | | | | | |
|---|---|---|---|---|---|---|---|---|---|
| 00001000 | 52 | 26 | 26 | 26 | 26 | 26 | 26 | 26 | 1 |

As shown the example of FIG. 4, up to nine 26-RUs may be allocated to the 20 MHz channel. When the RU allocation information of the common field 720 is set to “00000000” as shown in Table 1, the nine 26-RUs may be allocated to a corresponding channel (i.e., 20 MHz). In addition, when the RU allocation information of the common field 720 is set to “00000001” as shown in Table 1, seven 26-RUs and one 52-RU are arranged in a corresponding channel. That is, in the example of FIG. 4, the 52-RU may be allocated to the rightmost side, and the seven 26-RUs may be allocated to the left thereof.

The example of Table 1 shows only some of RU locations capable of displaying the RU allocation information.

For example, the RU allocation information may include an example of Table 2 below.

TABLE 2

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |

| | | | | | | | |
|---|---|---|---|---|---|---|---|
| 01000y₂y₁y₀ | 106 | 26 | 26 | 26 | 26 | 26 | 8 |

| | | | | | | |
|---|---|---|---|---|---|---|
| 01001y₂y₁y₀ | 106 | 26 | 26 | 26 | 52 | 8 |

“01000y2y1y0” relates to an example in which a 106-RU is allocated to the leftmost side of the 20 MHz channel, and five 26-RUs are allocated to the right side thereof. In this case, a plurality of STAs (e.g., user-STAs) may be allocated to the 106-RU, based on a MU-MIMO scheme. Specifically, up to 8 STAs (e.g., user-STAs) may be allocated to the 106-RU, and the number of STAs (e.g., user-STAs) allocated to the 106-RU is determined based on 3-bit information (y2y1y0). For example, when the 3-bit information (y2y1y0) is set to N, the number of STAs (e.g., user-STAs) allocated to the 106-RU based on the MU-MIMO scheme may be N+1.

In general, a plurality of STAs (e.g., user STAs) different from each other may be allocated to a plurality of RUs. However, the plurality of STAs (e.g., user STAs) may be allocated to one or more RUs having at least a specific size (e.g., 106 subcarriers), based on the MU-MIMO scheme.

As shown in FIG. 7, the user-specific field 730 may include a plurality of user fields. As described above, the number of STAs (e.g., user STAs) allocated to a specific channel may be determined based on the RU allocation information of the common field 720. For example, when the RU allocation information of the common field 720 is “00000000”, one user STA may be allocated to each of nine 26-RUs (e.g., nine user STAs may be allocated). That is, up to 9 user STAs may be allocated to a specific channel through an OFDMA scheme. In other words, up to 9 user STAs may be allocated to a specific channel through a non-MU-MIMO scheme.

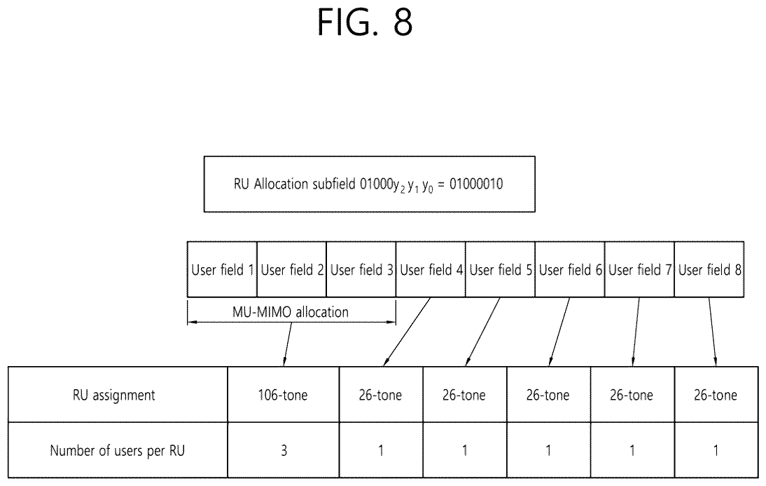

For example, when RU allocation is set to “01000y2y1y0”, a plurality of STAs may be allocated to the 106-RU arranged at the leftmost side through the MU-MIMO scheme, and five user STAs may be allocated to five 26-RUs arranged to the right side thereof through the non-MU MIMO scheme. This case is specified through an example of FIG. 8.

FIG. 8 illustrates an example in which a plurality of user STAs are allocated to the same RU through a MU-MIMO scheme.

For example, when RU allocation is set to “01000010” as shown in FIG. 7, a 106-RU may be allocated to the leftmost side of a specific channel, and five 26-RUs may be allocated to the right side thereof. In addition, three user STAs may be allocated to the 106-RU through the MU-MIMO scheme. As a result, since eight user STAs are allocated, the user-specific field 730 of HE-SIG-B may include eight user fields.

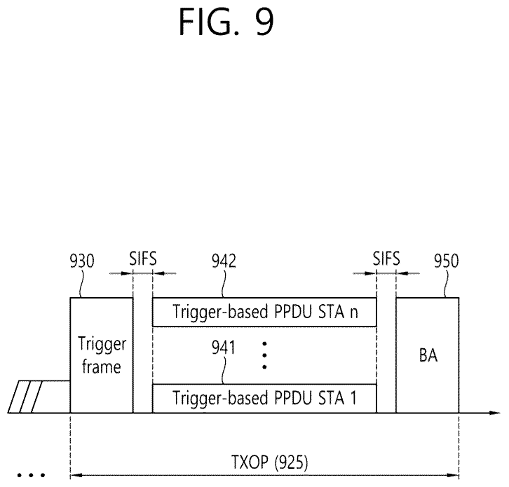

The eight user fields may be expressed in the order shown in FIG. 9. In addition, as shown in FIG. 7, two user fields may be implemented with one user block field.

The user fields shown in FIG. 7 and FIG. 8 may be configured based on two formats. That is, a user field related to a MU-MIMO scheme may be configured in a first format, and a user field related to a non-MIMO scheme may be configured in a second format. Referring to the example of FIG. 8, a user field 1 to a user field 3 may be based on the first format, and a user field 4 to a user field 8 may be based on the second format. The first format or the second format may include bit information of the same length (e.g., 21 bits).

Each user field may have the same size (e.g., 21 bits). For example, the user field of the first format (the first of the MU-MIMO scheme) may be configured as follows.

For example, a first bit (i.e., B0-B10) in the user field (i.e., 21 bits) may include identification information (e.g., STA-ID, partial AID, etc.) of a user STA to which a corresponding user field is allocated. In addition, a second bit (i.e., B11-B14) in the user field (i.e., 21 bits) may include information related to a spatial configuration. Specifically, an example of the second bit (i.e., B11-B14) may be as shown in Table 3 and Table 4 below.

TABLE 3

| | | N_{STS} | N_{STS} | N_{STS} | N_{STS} | N_{STS} | N_{STS} | N_{STS} | N_{STS} | Total | Number |
|---|---|---|---|---|---|---|---|---|---|---|---|
| Nᵤₛₑᵣ | B3 . . . B0 | [1] | [2] | [3] | [4] | [5] | [6] | [7] | [8] | N_{STS} | of entries |
| 2 | 0000-0011 | 1-4 | 1 | | | | | | | 2-5 | 10 |
| | 0100-0110 | 2-4 | 2 | | | | | | | 4-6 | |
| | 0111-1000 | 3-4 | 3 | | | | | | | 6-7 | |
| | 1001 | 4 | 4 | | | | | | | 8 | |
| 3 | 0000-0011 | 1-4 | 1 | 1 | | | | | | 3-6 | 13 |
| | 0100-0110 | 2-4 | 2 | 1 | | | | | | 5-7 | |
| | 0111-1000 | 3-4 | 3 | 1 | | | | | | 7-8 | |
| | 1001-1011 | 2-4 | 2 | 2 | | | | | | 6-8 | |
| | 1100 | 3 | 3 | 2 | | | | | | 8 | |
| 4 | 0000-0011 | 1-4 | 1 | 1 | 1 | | | | | 4-7 | 11 |
| | 0100-0110 | 2-4 | 2 | 1 | 1 | | | | | 6-8 | |
| | 0111 | 3 | 3 | 1 | 1 | | | | | 8 | |
| | 1000-1001 | 2-3 | 2 | 2 | 1 | | | | | 7-8 | |
| | 1010 | 2 | 2 | 2 | 2 | | | | | 8 | |

TABLE 4

| | | N_{STS} | N_{STS} | N_{STS} | N_{STS} | N_{STS} | N_{STS} | N_{STS} | N_{STS} | Total | Number |
|---|---|---|---|---|---|---|---|---|---|---|---|
| Nᵤₛₑᵣ | B3 . . . B0 | [1] | [2] | [3] | [4] | [5] | [6] | [7] | [8] | N_{STS} | of entries |
| 5 | 0000-0011 | 1-4 | 1 | 1 | 1 | 1 | | | | 5-6 | 7 |
| | 0100-0101 | 2-3 | 2 | 1 | 1 | 1 | | | | 7-8 | |
| | 0110 | 2 | 2 | 2 | 1 | 1 | | | | 8 | |
| 6 | 0000-0010 | 1-2 | 1 | 1 | 1 | 1 | 1 | | | 6-8 | 4 |
| | 0011 | 2 | 2 | 1 | 1 | 1 | 1 | | | 8 | |
| 7 | 0000-0001 | 1-2 | 1 | 1 | 1 | 1 | 1 | 1 | | 7-8 | 2 |
| 8 | 0000 | 1 | 1 | 1 | 1 | 1 | 1 | 1 | 1 | 8 | 1 |

As shown in Table 3 and/or Table 4, the second bit (e.g., B11-B14) may include information related to the number of spatial streams allocated to the plurality of user STAs which are allocated based on the MU-MIMO scheme. For example, when three user STAs are allocated to the 106-RU based on the MU-MIMO scheme as shown in FIG. 8, N_user is set to “3”. Therefore, values of N_STS[1], N_STS[2], and N_STS[3] may be determined as shown in Table 3. For example, when a value of the second bit (B11-B14) is “0011”, it may be set to N_STS[1]=4, N_STS[2]=1, N_STS[3]=1. That is, in the example of FIG. 8, four spatial streams may be allocated to the user field 1, one spatial stream may be allocated to the user field 1, and one spatial stream may be allocated to the user field 3.

As shown in the example of Table 3 and/or Table 4, information (i.e., the second bit, B11-B14) related to the number of spatial streams for the user STA may consist of 4 bits. In addition, the information (i.e., the second bit, B11-B14) on the number of spatial streams for the user STA may support up to eight spatial streams. In addition, the information (i.e., the second bit, B11-B14) on the number of spatial streams for the user STA may support up to four spatial streams for one user STA.

In addition, a third bit (i.e., B15-18) in the user field (i.e., 21 bits) may include modulation and coding scheme (MCS) information. The MCS information may be applied to a data field in a PPDU including corresponding SIG-B.

An MCS, MCS information, an MCS index, an MCS field, or the like used in the present specification may be indicated by an index value. For example, the MCS information may be indicated by an index 0 to an index 11. The MCS information may include information related to a constellation modulation type (e.g., BPSK, QPSK, 16-QAM, 64-QAM, 256-QAM, 1024-QAM, etc.) and information related to a coding rate (e.g., ½, ⅔, ¾, ⅚e, etc.). Information related to a channel coding type (e.g., LCC or LDPC) may be excluded in the MCS information.

In addition, a fourth bit (i.e., B19) in the user field (i.e., 21 bits) may be a reserved field.

In addition, a fifth bit (i.e., B20) in the user field (i.e., 21 bits) may include information related to a coding type (e.g., BCC or LDPC). That is, the fifth bit (i.e., B20) may include information related to a type (e.g., BCC or LDPC) of channel coding applied to the data field in the PPDU including the corresponding SIG-B.

The aforementioned example relates to the user field of the first format (the format of the MU-MIMO scheme). An example of the user field of the second format (the format of the non-MU-MIMO scheme) is as follows.

A first bit (e.g., B0-B10) in the user field of the second format may include identification information of a user STA. In addition, a second bit (e.g., B11-B13) in the user field of the second format may include information related to the number of spatial streams applied to a corresponding RU. In addition, a third bit (e.g., B14) in the user field of the second format may include information related to whether a beamforming steering matrix is applied. A fourth bit (e.g., B15-B18) in the user field of the second format may include modulation and coding scheme (MCS) information. In addition, a fifth bit (e.g., B19) in the user field of the second format may include information related to whether dual carrier modulation (DCM) is applied. In addition, a sixth bit (i.e., B20) in the user field of the second format may include information related to a coding type (e.g., BCC or LDPC).

FIG. 9 illustrates an operation based on UL-MU. As illustrated, a transmitting STA (e.g., AP) may perform channel access through contending (e.g., a backoff operation), and may transmit a trigger frame 930. That is, the transmitting STA may transmit a PPDU including the trigger frame 930. Upon receiving the PPDU including the trigger frame, a trigger-based (TB) PPDU is transmitted after a delay corresponding to SIFS.

TB PPDUs 941 and 942 may be transmitted at the same time period, and may be transmitted from a plurality of STAs (e.g., user STAs) having AIDs indicated in the trigger frame 930. An ACK frame 950 for the TB PPDU may be implemented in various forms.

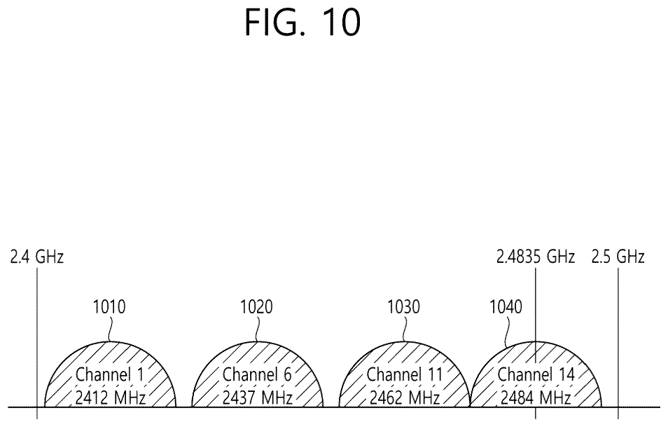

FIG. 10 illustrates an example of a channel used/supported/defined within a 2.4 GHz band.

The 2.4 GHz band may be called in other terms such as a first band. In addition, the 2.4 GHz band may imply a frequency domain in which channels of which a center frequency is close to 2.4 GHz (e.g., channels of which a center frequency is located within 2.4 to 2.5 GHz) are used/supported/defined.

A plurality of 20 MHz channels may be included in the 2.4 GHz band. 20 MHz within the 2.4 GHz may have a plurality of channel indices (e.g., an index 1 to an index 14). For example, a center frequency of a 20 MHz channel to which a channel index 1 is allocated may be 2.412 GHz, a center frequency of a 20 MHz channel to which a channel index 2 is allocated may be 2.417 GHz, and a center frequency of a 20 MHz channel to which a channel index N is allocated may be (2.407+0.005*N) GHz. The channel index may be called in various terms such as a channel number or the like. Specific numerical values of the channel index and center frequency may be changed.

FIG. 10 exemplifies 4 channels within a 2.4 GHz band. Each of 1st to 4th frequency domains 1010 to 1040 shown herein may include one channel. For example, the 1st frequency domain 1010 may include a channel 1 (a 20 MHz channel having an index 1). In this case, a center frequency of the channel 1 may be set to 2412 MHz. The 2nd frequency domain 1020 may include a channel 6. In this case, a center frequency of the channel 6 may be set to 2437 MHz. The 3rd frequency domain 1030 may include a channel 11. In this case, a center frequency of the channel 11 may be set to 2462 MHz. The 4th frequency domain 1040 may include a channel 14. In this case, a center frequency of the channel 14 may be set to 2484 MHz.

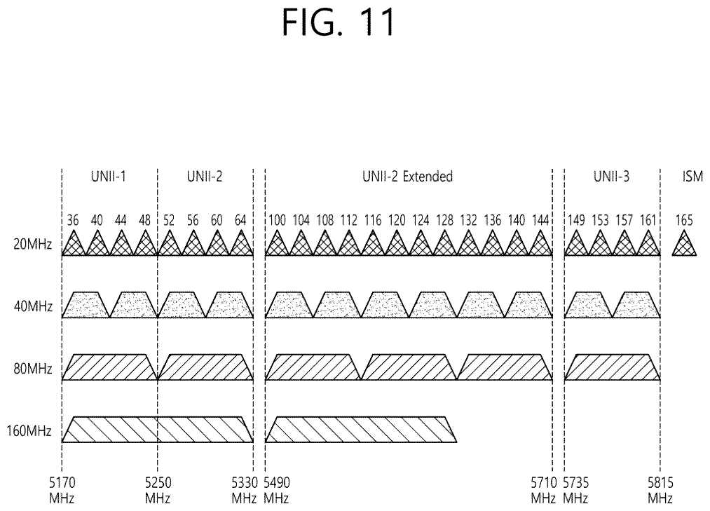

FIG. 11 illustrates an example of a channel used/supported/defined within a 5 GHz band.

The 5 GHz band may be called in other terms such as a second band or the like. The 5 GHz band may imply a frequency domain in which channels of which a center frequency is greater than or equal to 5 GHz and less than 6 GHz (or less than 5.9 GHz) are used/supported/defined. Alternatively, the 5 GHz band may include a plurality of channels between 4.5 GHz and 5.5 GHz. A specific numerical value shown in FIG. 11 may be changed.

A plurality of channels within the 5 GHz band include an unlicensed national information infrastructure (UNII)-1, a UNII-2, a UNII-3, and an ISM. The INII-1 may be called UNII Low. The UNII-2 may include a frequency domain called UNII Mid and UNII-2Extended. The UNII-3 may be called UNII-Upper.

A plurality of channels may be configured within the 5 GHz band, and a bandwidth of each channel may be variously set to, for example, 20 MHz, 40 MHz, 80 MHz, 160 MHz, or the like. For example, 5170 MHz to 5330 MHz frequency domains/ranges within the UNII-1 and UNII-2 may be classified into eight 20 MHz channels. The 5170 MHz to 5330 MHz frequency domains/ranges may be classified into four channels through a 40 MHz frequency domain. The 5170 MHz to 5330 MHz frequency domains/ranges may be classified into two channels through an 80 MHz frequency domain. Alternatively, the 5170 MHz to 5330 MHz frequency domains/ranges may be classified into one channel through a 160 MHz frequency domain.

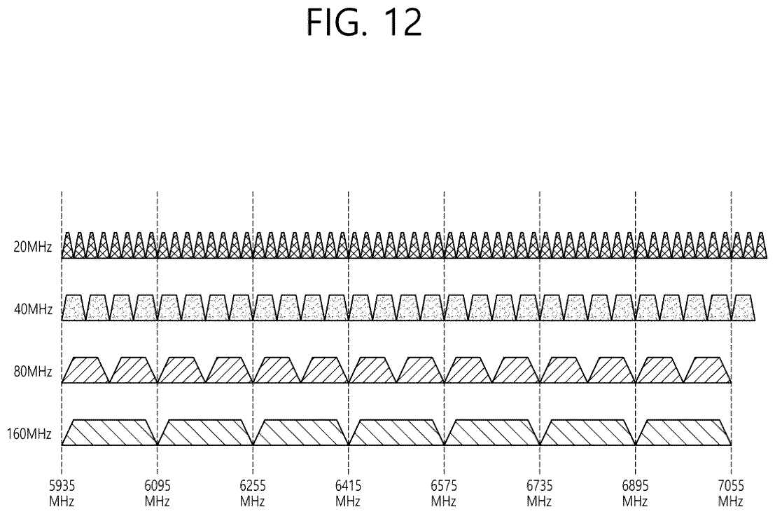

FIG. 12 illustrates an example of a channel used/supported/defined within a 6 GHz band.

The 6 GHz band may be called in other terms such as a third band or the like. The 6 GHz band may imply a frequency domain in which channels of which a center frequency is greater than or equal to 5.9 GHz are used/supported/defined. A specific numerical value shown in FIG. 12 may be changed.

For example, the 20 MHz channel of FIG. 12 may be defined starting from 5.940 GHz. Specifically, among 20 MHz channels of FIG. 12, the leftmost channel may have an index 1 (or a channel index, a channel number, etc.), and 5.945 GHz may be assigned as a center frequency. That is, a center frequency of a channel of an index N may be determined as (5.940+0.005*N) GHz.

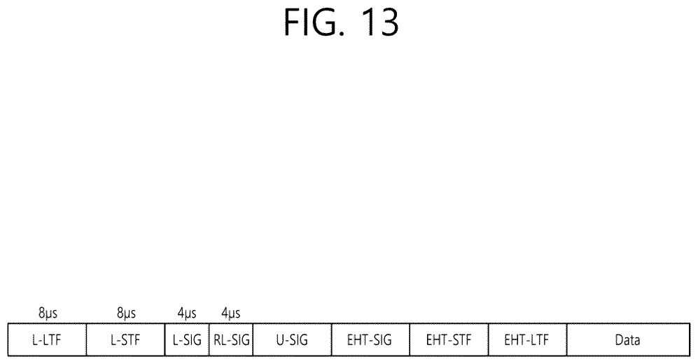

Accordingly, an index (or channel number) of the 2 MHz channel of FIG. 12 may be 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. In addition, according to the aforementioned (5.940+0.005*N) GHz rule, an index of the 40 MHz channel of FIG. 13 may be 3, 11, 19, 27, 35, 43, 51, 59, 67, 75, 83, 91, 99, 107, 115, 123, 131, 139, 147, 155, 163, 171, 179, 187, 195, 203, 211, 219, 227.

Although 20, 40, 80, and 160 MHz channels are illustrated in the example of FIG. 12, a 240 MHz channel or a 320 MHz channel may be additionally added.

Hereinafter, a PPDU transmitted/received in an STA of the present specification will be described.

FIG. 13 illustrates an example of a PPDU used in the present specification.

The PPDU of FIG. 13 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

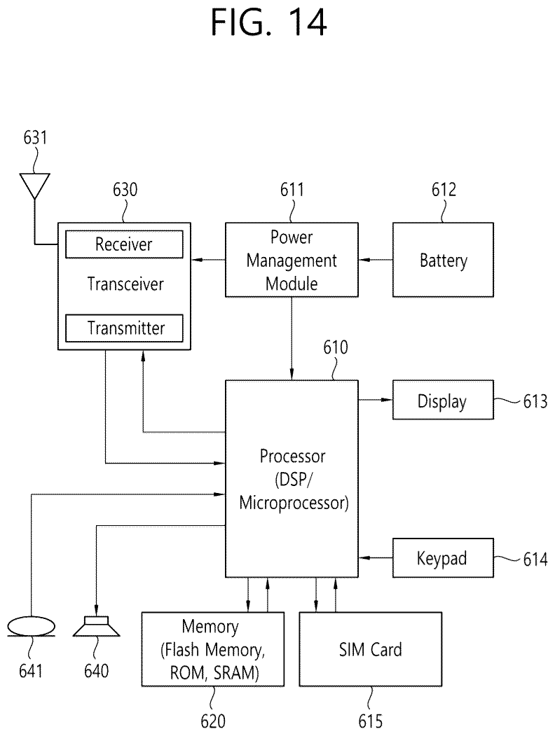

FIG. 14 illustrates an example of a modified transmission device and/or receiving device of the present specification.

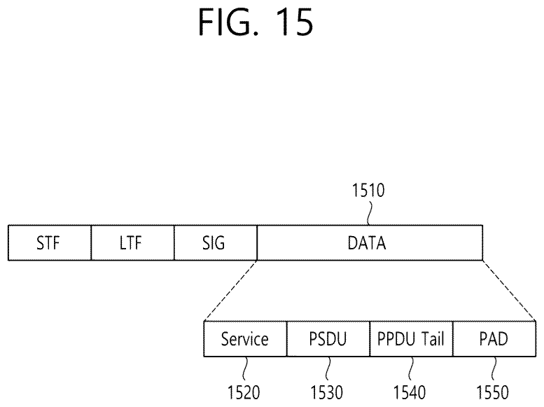

Each device/STA of the sub-figure (a)/(b) of FIG. 1 may be modified as shown in FIG. 15. A transceiver 630 of FIG. 14 may be identical to the transceivers 113 and 123 of FIG. 1. The transceiver 630 of FIG. 14 may include a receiver and a transmitter.

A processor 610 of FIG. 14 may be identical to the processors 111 and 121 of FIG. 1. Alternatively, the processor 610 of FIG. 14 may be identical to the processing chips 114 and 124 of FIG. 1.

A memory 620 of FIG. 14 may be identical to the memories 112 and 122 of FIG. 1. Alternatively, the memory 620 of FIG. 14 may be a separate external memory different from the memories 112 and 122 of FIG. 1.

Referring to FIG. 14, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 14, a speaker 640 may output a result related to a sound processed by the processor 610. A microphone 641 may receive an input related to a sound to be used by the processor 610.

The following describes the technical features of this specification.

Examples of the present disclosure may relate to a non-HT PPDU format. For example, a non-HT PPDU may be the PPDU disclosed at the top of FIG. 3. For example, that PPDU may include an LTF (or L-LTF) signal for channel estimation. The PPDU may also include an STF (or L-STF) signal contiguous to the LTF. The PPDU may also include a SIG (or L-SIG) signal/field contiguous to the STF. The PPDU may also include data signals/fields contiguous to the SIG signals/fields.

The non-HT PPDU may have a bandwidth of, for example, 20 MHz. For example, the non-HT PPDU may be transmitted in a form that is duplicated in the frequency domain. For example, a non-HT PPDU with a 20 MHz bandwidth may be duplicated in the frequency domain, resulting in a total of two non-HT PPDUs. In this case, the total bandwidth of the duplicated non-HT PPDUs may be 40 MHz.

The technical features of this specification may relate to the Service (field) contained within the data field.

FIG. 15 illustrates an example of a service field included in a Non-HT PPDU.

As shown, a PPDU of FIG. 15 may include a data field 1510. The data field 1510 may include a PSDU 1530 configured based on the MAC PPDU (MPPDU). The data field 1510 may be subject to scrambling as described below.

The data field 1510 may sequentially include a service field 1520, a PSDU 1530, a tail 1540, and a pad 1550. The Tail 1540 may be included if a binary convolutional code (BCC) forward error correction (FEC) technique is applied to the non-HT PPDU. The fields 1520, 1530, 1540, 1550 may be contiguous with each other, as shown in FIG. 15.

The following describes technical features related to the service field 1520.

The service field may comprise 16 bits (i.e., bits B0 to/through B15).

According to one example, of the 16 bits, bits B0 to/through B6 may all have a value of zero. The corresponding bits/information/field/signal (i.e., bits B0 to B6) may be used for Scrambler Initialization. In this case, bits B7 to/through B15 of the 16 bits may all have a reserved value (e.g., 0). The corresponding reserved values may be ignored by the receiving end/STA.

In another example, bits B0 to/through B6 of the 16 bits may all have a value of zero. Bit B7 of the 16 bits may contain information related to the total bandwidth of the non-HT PPDU. For example, bit B7 of the 16 bits may be set to “1” only when a predefined condition is satisfied, and may have a reserved value (e.g., 0) when the condition is not satisfied. Specifically, the value of bit B7 of the 16 bits may be set to 1 when the non-HT PPDU is configured by an EHT STA (e.g., EHT STA has dot11EHTOptionImplemented equal to true), the non-HT PPDU is duplicated in a frequency domain (e.g., 6G frequency domain), and the total bandwidth of the duplicated non-HT PPDU is 320 MHz.

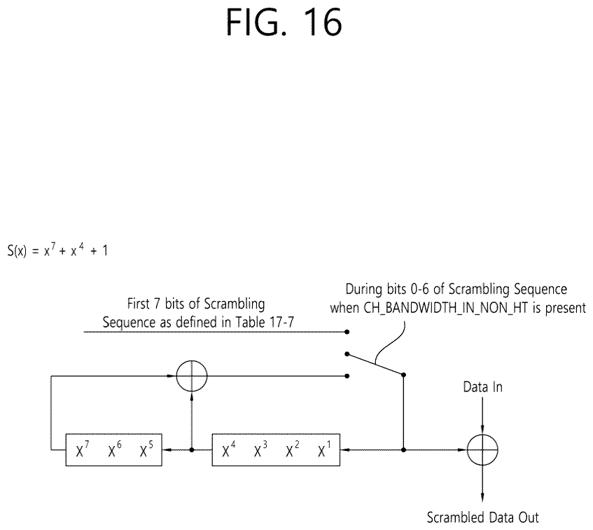

FIG. 16 illustrates an example of a data scrambler.

Scrambling may be performed by the apparatus of FIG. 16. The scrambling may be applied to the service field 1520, PSDU 1530, tail 1540, and pad 1550 described above. The scrambler may utilize sequences of various lengths. For example, a sequence having a length of 127 (elements) can be used. For example, the scrambler may place the octets of the PSDU, in which case the B0 bit may be placed first and the B7 bit may be placed last. As shown in FIG. 16, the scrambler generator polynomial may be defined as S(x)=X\hat{ }7+X\hat{ }4+1.

For example, a sequence of length 127 (e.g., a 127-bit sequence) may be generated by iterating over the sequence below.

$$Sequence = 00001 \; 110 \; 1 \; 1110010 \; 11001001 \; 00000010 \; 00100110 \; 00101110 \; 10110110 \; 00001100 \; 11010100 \; 11100111 \; 10110100 \; 00101010 \; 1111010 \; 01010001 \; 10111000 \; 1111111 \qquad [ Equation 1 ]$$

The transmitting STA and receiving STA may use the same scrambler. When transmitting, the first seven bits of the scrambling sequence (i.e., bits B0 to/through B6) may be used to set the state of the scrambler. The receiving STA may estimate the initial state of the scrambler from the 7 LSBs of the scrambled service field.

The following specification describes the technical features used in the Next wi-fi specification. The technical features of this specification may be applied to any new wireless LAN system. The new wireless LAN system may be referred to by various names, and this specification is not limited by any particular name. For example, the new wireless LAN system may be referred to by various names, such as beyond 11be, Next wi-fi, etc.

In the newly defined next wi-fi environment beyond 11be, an extended BW may be used. The extended BW may mean a larger bandwidth compared to the BW of the existing IEEE 802.11be standard. In other words, the extended BW may mean a bandwidth of 320 MHz or more, or a bandwidth in excess of 320 MHz or more. For example, the extended BW may be a bandwidth of at least one of 320 MHz, 480 MHz, 560 MHz, and/or 640 MHz.

For example, the total bandwidth occupied by non-HT PPDUs (or non-HT DUP PPDUs, non-HT Duplicate PPDUs) may be equal to the extended BW above. In this case, conventional techniques may not be able to accurately indicate the total bandwidth of non-HT PPDUs. Accordingly, a technical feature is proposed that accurately indicates the total bandwidth of a non-HT PPDU (or non-HT DUP PPDU) (e.g., the extended BW of the non-HT PPDU (or non-HT DUP PPDU, non-HT Duplicate PPDU)) when the non-HT PPDU is transmitted/received.

As illustrated below, an example of the present disclosure may use the service field 1520 described above to indicate the transmit/receive bandwidth (i.e., total bandwidth) of the non-HT PPDU (or non-HT DUP PPDU), i.e., a technique may be proposed for indicating the extended BW of the non-HT PPDU (or non-HT DUP PPDU) using at least one bit of bits B0 to/through B15 of the service field 1520 described above.

In other words, the B5/B6/B7/B8/B9/B10 bits described herein may be the B5/B6/B7/B8/B9/B10 bits of the service field 1520 described above.

An example of this specification is described below based on a number of tables.

When transmitting the non-HT (or non-HT DUP) PPDU described above, information related to the BW on which the PPDU is transmitted may be indicated based on the service field (16 bits), i.e., in IEEE 802.11be, considering 320 MHz, the 320 MHz is indicated using the B7 bit of the reserved B7 to B15 bits, together with two bits (B5 and B6 bits) of the seven bits (B0 and B6 bits) used for scrambler initiation. The B5/B6 bits of the Service field may be the B5/B6 bits of a preset sequence used by the data scrambler (e.g., the example of FIG. 16) (e.g., a sequence of length 127 generated based on Equation 1). Stated differently, the value of the B5/B6 bits of the first 7 bits, or 7 LSBs, of a preset sequence (e.g., a 127-length sequence generated based on Equation 1) used in the data scrambler (e.g., the example of FIG. 16) may be the same as the value of the B5/B6 bits of the Service field.

TABLE 5

| BW | B5 | B6 | B7 |
|---|---|---|---|
| 20 MHz | 0 | 0 | 0 |
| 40 MHz | 0 | 1 | 0 |
| 80 MHz | 1 | 0 | 0 |
| 160 MHz | 1 | 1 | 0 |
| 320 MHz | 0 | 0 | 1 |
| Reserved | 0 | 1 | 1 |
| Reserved | 1 | 0 | 1 |
| Reserved | 1 | 1 | 1 |

The above examples do not dictate an extended BW for the non-HT PPDU (or non-HT DUP PPDU), as shown in Table 5. Accordingly, the following additional examples are provided. In this specification, the value of the service field (in particular, the conventional reserved bit) may be utilized to indicate information related to the extended BW (e.g., 480 MHz/560 MHz/640 MHz).

Technical Feature 1: The following methods relate to the indication of extended BW by reusing the 11be indication method.

Technical Feature 1.A: As shown in Table 5, 11be sets the B5 bit, B6 bit, and B7 bit as follows for 320 MHz indication.

Technical Feature 1.A.i: If the total bandwidth of the Non-HT (or non-HT DUP) PPDU described above is 320 MHz, the bandwidth may be indicated according to the following technique.

TABLE 6

| BW | B5 | B6 | B7 |
|---|---|---|---|
| 320 MHz | 0 | 0 | 1 |

Technical Feature 1.A.ii: By setting bits B5 and B6 to zero as described above, a previously undefined bit may be used to indicate Extended BW as follows

Technical Feature 1.A.ii.1: In a related example, bit B7 may always be set to 1 to indicate Extended BW.

Technical Feature 1.A.ii.2: As described below, it may be considered to provide separate indications for 480 MHz BW and 640 MHz BW. In this case, the BW indication may be performed by bits B5, B6, and B7 of Table 7 below.

TABLE 7

| BW | B5 | B6 | B7 |
|---|---|---|---|
| 320 MHz | 0 | 0 | 1 |
| 480 MHz | 0 | 1 | 1 |
| 640 MHz | 1 | 0 | 1 |
| Reserved | 1 | 1 | 1 |

Technical Feature 1.A.ii.2.A: For BW indication for 480 MHz, bits B5 and B6 may be set to 0 and 1, respectively, as shown in Table 7.

Technical Feature 1.A.ii.2.B: For BW indication for 640 MHz as shown in Table 7, bits B5 and B6 shall be set to 1 and 0, respectively.

The above bit configuration for 480/640 MHz may be varied as follows.

Technical Feature 1.A.ii.3: In the above, the 480 MHz case can be defined as the puncturing case of 640 Mhz. Therefore, considering only the indication for 640 MHz, it may be constructed as follows, i.e., the explicit indication for the 480 MHz case may be omitted.

TABLE 8

| BW | B5 | B6 | B7 |
|---|---|---|---|
| 320 MHz | 0 | 0 | 1 |
| 640 MHz | 0 | 1 | 1 |
| Reserved | 1 | 0 | 1 |
| Reserved | 1 | 1 | 1 |

Technical feature 1.A.ii.3.A: For the 640 MHz indication, bits B5, B6, and B7 are set to 0, 1, and 1, respectively, as shown in the table above; the bit configuration for the 640 MHz indication may be varied by configuring other reserved bits.

Technical Feature 1.A.ii.3.B: In order to eliminate signaling ambiguity with 320 MHz, the indication for 640 MHz may be configured as [B5 B6 B7]=[1 1 1].

Technical Feature 1.A.ii.4: In addition to the above, 480 MHz, 560 MHz and 640 MHz may be considered as Extended BW(s). Considering the above BW(s), the following example BW indication may be proposed.

Technical Feature 1.A.ii.4.A: For the 480 MHz BW indication, B5=0, B6=1, and B7=1 may be set.

Technical Feature 1.A.ii.4.B: For a 560 MHz BW indication, B5 =1, B6 =0, B7 =1.

Technical characteristic 1.A.ii.4.C: For 640 MHz BW indication, B5 =1, B6 =1, B7=1 may be set.

The above can be illustrated with Table 9.

TABLE 9

| BW | B5 | B6 | B7 |
|---|---|---|---|
| 320 MHz | 0 | 0 | 1 |
| 480 MHz | 0 | 1 | 1 |
| 560 MHz | 1 | 0 | 1 |
| 640 MHz | 1 | 1 | 1 |

In other words, as described above, the B5/B6/B7 bits shown in Tables 7/8/9 may be the B5/B6/B7 bits of the service field 1520 described above. Further, the B5/B6 bits of the service field may be the B5/B6 bits of a preset sequence used in a data scrambler (e.g., the example of FIG. 16) (e.g., a sequence having a length of 127 (elements) generated based on Equation 1). Stated differently, the value of the B5/B6 bits of the first 7 bits (first 7 bits, or 7 LSBs) of the preset sequence (e.g., the 127-length sequence described in Equation 1) used in the data scrambler (e.g., the example of FIG. 16) may be the same as the value of the B5/B6 bits of the service field.

Technical Feature 2: An example of using one bit of the reserved bits of the service field (e.g., bits B8 to/through B15) to indicate the Extended BW described above is described.

Technical Feature 2.A: The one bit additionally used may be bit B8.

Technical Feature 2.A.i: The B8 bit is just one example, other reserved one bits may be used.

Technical Feature 2.B: The technique for indicating the extended BW using the B8 bit may be as follows.

Technical Feature 2.B.i: In one example of using bit B8, bits B5 and B6 may always be set to zero.

Technical Feature 2.B.ii: An example of using B7 and B8 bits to indicate an extended BW may be as shown in Table 10 below.

Technical Feature 2.B.ii.1: The B7 bit is already used and can be leveraged to construct the example in Table 10.

Technical Feature 2.B.iii: A specific example is shown in Table 10 below.

TABLE 10

| BW | B7 | B8 |
|---|---|---|
| Reserved | 0 | 0 |
| 480 MHz | 0 | 1 |
| 320 MHz | 1 | 0 |
| 640 MHz | 1 | 1 |

Technical Feature 2.B.iv: In a variation of the above, the 480 MHz case may be treated as a 640 MHz puncturing case, i.e., the 480 MHz case may not be explicitly specified. A relevant embodiment may be as shown in Table 10 below.

TABLE 11

| BW | B7 | B8 |
|---|---|---|
| Reserved | 0 | 0 |
| Reserved | 0 | 0 |
| 320 MHz | 1 | 0 |
| 640 MHz | 1 | 1 |

Technical Feature 2.C: Additionally or alternatively, it is also possible for the B8 bit to indicate only 640 MHz.

Technical Feature 2.C.i: In this case, the 480 MHz case may be treated as the 640 MHz puncturing case, i.e., the 480 MHz case may not be explicitly indicated.

Technical Feature 2.C.ii: An example of using bits B5 to B8 to indicate 640 MHz in accordance with the above is as shown in the example in Table 12 below.

TABLE 12

| BW | B5 | B6 | B7 | B8 |
|---|---|---|---|---|
| 640 MHz | 0 | 0 | 0 | 1 |

Technical Feature 2.C.ii.1: The bits not mentioned above can be treated as reserved bits.

Technical Feature 2.C.iii: Since one bit (i.e., bit B8) is used to indicate 640 MHz as described above, the receiving STA can directly determine the BW by setting the above bit.

In other words, as described above, the B5/B6/B7/B8 bits related with Tables Oct. 11, 2012 may be the B5/B6/B7/B8 bits of the service field 1520 described above. Further, the B5/B6 bits of the service field may be the B5/B6 bits of a preset sequence used by the data scrambler (e.g., the example of FIG. 16), such as a sequence of length 127 generated based on Equation 1. Stated differently, the value of the B5/B6 bits of the first 7 bits (first 7 bits, or 7 LSBs) of the preset sequence (e.g., the 127-length sequence described in Equation 1) used by the data scrambler (e.g., the example of FIG. 16) may be the same as the value of the B5/B6 bits of the service field.

Technical Feature 3: Additionally or alternatively, techniques for specifying different extended BWs, such as 480/560/640 MHz, are possible. For example, two of the existing reserved bits (e.g., bits B8 and B9) may be allocated.

Technical Feature 3.A: In the following example, bit B7 may be set to 1 to indicate that the extended BW is greater than or equal to 320 MHz.

Technical Feature 3.B: Bits B8 and B9 may be utilized for further extended BW indication. To indicate the corresponding BW, the B7/B8/B9 bits may be configured as shown in Table 13 below.

TABLE 13

| BW | B7 | B8 | B9 |
|---|---|---|---|
| 320 MHz | 1 | 0 | 0 |
| 480 MHz | 1 | 1 | 0 |
| 560 MHz | 1 | 0 | 1 |
| 640 MHz | 1 | 1 | 1 |

Technical Feature 3.B.1: The combination of bits in Table 13 above is an example; other combinations of bits are possible.

Technical Feature 3.C: In the above, bit B7 is set to 1 to align with the existing 320 MHz configuration/setting. Alternatively, the B7 bit can be set to 0, in which case only bits B8 and B9 can be used to indicate 480 MHz/560 MHz/640 MHz to form an example in Table 14 below.

TABLE 14

| BW | B7 | B8 | B9 |
|---|---|---|---|
| 320 MHz | 1 | 0 | 0 |
| 480 MHz | 0 | 1 | 0 |
| 560 MHz | 0 | 0 | 1 |
| 640 MHz | 0 | 1 | 1 |

In other words, as described above, the B7/B8/B9 bits associated with Tables 13/14 may be the B7/B8/B9 bits of the service field 1520 described above.

Technical Feature 4: For example, to indicate the extend BW described above, similar to the 320 MHz case, an example of utilizing a separate bit indication (3 bits: B8, B9, B10) for each corresponding BW is described. The details are as follows

Technical Feature 4.A: To indicate the newly supported Extended BW(s) (e.g., 480/560/640 MHz), bits B8, B9, and B10 of the reserved bits may be used.

Technical feature 4.A.i: In this case, the B8 bit may be used as follows. Specifically, the B8 bit may be set to 1 to indicate a 480 MHz BW. If a BW other than 480 MHz BW is indicated, bit B8 may be set to 0.

Technical Feature 4.A.i.1: For example, if bit B8 is set to 1, both bits B5 and B6, which are used to represent BW, may be set to 0.

Technical Feature 4.A.i.1.A: If the above example applies, bit B7 may be set to either 0 or 1.

Technical Feature 4.A.i.2: The above example of setting bits B5 and B6 is an example. Other bit combinations are possible, for example, [B5, B6]=[1, 1] to indicate 480 MHz BW.

Technical Feature 4.A.ii: For example, bit B9 may be set to 1 to indicate a 560 MHz BW. If a BW other than 560 MHz BW is indicated, for example, bit B9 may be set to 0.

Technical Feature 4.A.ii.1: When bit B9 is set to 1, both bits B5 and B6, which are used to indicate the BW, may be set to 0.

Technical Feature 4.A.ii.1.A: In the example above, bit B7 may be set to either 0 or 1.

Technical Feature 4.A.ii.1.B: The above setting of bits B5 and B6 is an example. Accordingly, other bit combinations are possible, for example, [B5, B6]=[1, 1] to indicate a 560 MHz BW.

Technical Feature 4.A.iii: For example, bit B10 may be set to 1 to indicate a 640 MHz BW. If a BW other than the 640 MHz BW is indicated, for example, bit B19 may be set to 0.

Technical Feature 4.A.iii.1: When bit B10 is set to 1, both bits B5 and B6, which are used to represent BW, may be set to 0.

Technical Feature 4.A.iii.1.A: In the above example, bit B7 may be set to either 0 or 1.

Technical Feature 4.A.iii.1.B: The above setting of bits B5 and B6 is an example. Other bit combinations are possible, for example, [B5, B6]=[1, 1] to indicate 640 MHz.

Technical Feature 4.B: The technical features described above may be embodied by the examples in Table 15. The example in Table 15 is an example where the B7 bit is set to 1.

TABLE 15

| BW | B7 | B8 | B9 | B10 |
|---|---|---|---|---|
| 320 MHz | 1 | 0 | 0 | 0 |
| 480 MHz | 1 | 1 | 0 | 0 |
| 560 MHz | 1 | 0 | 1 | 0 |
| 640 MHz | 1 | 0 | 0 | 1 |

In other words, as described above, the B5/B6/B7/B8/B9/B10 bits related to Table 15 may be the B5/B6/B7/B8/B9/B10 bits of the service field 1520 described above. Further, the B5/B6 bits of the service field may be the B5/B6 bits of a preset sequence used by the data scrambler (e.g., the example of FIG. 16), such as a 127-length sequence generated based on equation 1. Stated differently, the value of the B5/B6 bits of the first 7 bits (first 7 bits, or 7 LSBs) of the preset sequence (e.g., the 127-length sequence described in Equation 1) used by the data scrambler (e.g., the example of FIG. 16) may be the same as the value of the B5/B6 bits of the service field.

The above examples relate to bandwidths above the 320 MHz band. For example, if the total bandwidth of the non-HT PPDU is 20/40/80/160 MHz, the method defined in the prior art IEEE 802.11be standard may be equally used.

The various technical features described above may be applied to the transmit STA and receive STA of a WLAN system.

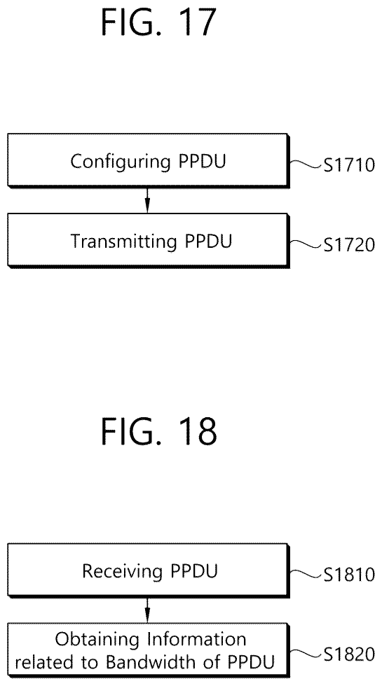

FIG. 17 is a procedural flow diagram illustrating operations performed at a transmitting STA. For example, the operations of FIG. 17 may be performed at an AP STA or a non-AP STA, i.e., the operations of FIG. 17 may be applied to a downlink or an uplink.

Based on S1710, the transmitting STA may configure a PPDU. The PPDU may be a non-HT PPDU (or non-HT DUP PPDU) as described above. It may be a non-HT (High Throughput) PPDU (Physical Protocol Data Unit) comprising a preamble and data fields. The preamble may include, for example, the STF, LTF, and SIG signals shown in FIG. 15 and the like. The data field may include a service field, and the service field may include bits B0 to/through B15 as described above. The non-HT PPDU may be duplicated in frequency (domain).

The duplicated non-HT PPDU may have a bandwidth of 320/480/560/640 MHz.

Information related to the total bandwidth of the non-HT PPDU (e.g., 320/480/560/640 MHz) may be included in the service field.

The service field may be configured in various ways, such as in at least one example of Table 6 to Table 15 above. For example, if the service field is based on the example of Tables Oct. 11, 2012, the value of bit B8 of the service field may be related to whether the total bandwidth exceeds 320 MHz, i.e., as described in Tables Oct. 11, 2012, the value of bit B8 may be related to whether the total bandwidth exceeds 320 MHz.

The PPDU configured based on S1710 may be transmitted to the receiving STA according to step S1720. For example, the PPDU may be transmitted over a 6 GHz band as described above.

FIG. 18 is a procedural flow diagram illustrating operations performed at the receiving STA. For example, the operations of FIG. 18 may be performed at an AP STA or a non-AP STA, i.e., the operations of FIG. 18 may apply to a downlink or an uplink.

In accordance with step S1810, the receiving STA may receive a PPDU configured by the transmitting STA. The PPDU may be a non-HT PPDU (or non-HT DUP PPDU) as described above. The PPDU may be a non-HT High Throughput (HT) Physical Protocol Data Unit (PPDU) comprising a preamble and data fields. The preamble may include, for example, the STF, LTF, and SIG signals shown in FIG. 15 and the like. The data field may include a service field, and the service field may include bits B0 to/through B15 as described above. The non-HT PPDU may be duplicated in frequency (domain).

The duplicated non-HT PPDU may have a bandwidth of 320/480/560/640 MHz. Information about the total bandwidth of the non-HT PPDU (e.g., 320/480/560/640 MHz) may be included in the service field above.

The service field may be variously configured, as in the example of at least one of Tables 6 to 15 above. For example, if the service field is based on an example of Tables Oct. 11, 2012, the value of bit B8 of the service field may be related to whether the total bandwidth exceeds 320 MHz, i.e., as described in Tables Oct. 11, 2012, the value of bit B8 may be related to whether the total bandwidth exceeds 320 MHz.

The receiving STA, upon receiving the PPDU in step S1810, may obtain information about the total bandwidth of the PPDU based on the B5/B6/B7/B8/B9/B10 bits described above (S1820).

Each of the operations illustrated in FIGS. 17 and 18 may be performed by the apparatus of FIGS. 1 and/or 14. For example, the transmit STA of FIG. 17 or the receive STA of FIG. 18 may be implemented by the apparatus of FIG. 1 and/or FIG. 14. The processor of FIG. 1 and/or FIG. 14 may perform each of the operations of FIGS. 17 through 18 described above. Further, the transceiver of FIG. 1 and/or FIG. 14 may perform each of the operations described in FIGS. 17 through 18.

The apparatus/device (e.g., transmitting STA and receiving STA) proposed herein do not necessarily comprise transceivers and may be implemented in the form of a chip including a processor and memory. Such devices may generate/store transmit/receive PPDUs according to any of the examples described above. Such a device may be connected to a separately manufactured transceiver to support actual transmission and reception.

The present disclosure proposes a computer readable medium (CRM), which may be implemented in various forms. A computer readable medium according to the present disclosure may be encoded with at least one computer program comprising instructions. The instructions stored on the medium may control the processor illustrated in FIG. 1 and/or FIG. 14, i.e., the instructions stored on the medium may control the processor described herein to perform the operations of the transmit/receive STA described above (e.g., FIGS. 17 to 18).

The technical features of the disclosure described above are applicable to a variety of applications or business models. For example, the technical features described above may be applied for wireless communication in devices that support artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

1. A method in a wireless local area network (WLAN) system, the method comprising:
configuring a non-High Throughput (HT) Physical Protocol Data Unit (PPDU) comprising a preamble and a data field,
wherein the data field includes a service field, and the service field includes bits B0 to B15,
wherein the non-HT PPDU is duplicated in frequency domain,
wherein the service field comprises information related to a total bandwidth of the duplicated non-HT PPDU,
wherein a value of bit B8 in the service field relates to whether the total bandwidth exceeds 320 MHz; and
transmitting the duplicated non-HT PPDU.

2. The method of claim 1, wherein based on the total bandwidth exceeding 320 MHz, values of bits B5, B6, and B7 in the service field are set to zero,
wherein bits B5 and B6 in the service field are bits B5 and B6 of a scrambling sequence applied to the data field.

3. The method of claim 1,
wherein based on the total bandwidth being set to 320 MHz, a value of bit B7 in the service field is set to one (1), and a value of bit B8 in the service field is set to zero (0),
wherein based on the total bandwidth being set to 480 MHz, a value of bit B7 in the service field is set to zero (0), and a value of bit B8 in the service field is set to one (1),
wherein based on the total bandwidth being set to 640 MHz, a value of bit B7 in the service field is set to one (1), and a value of bit B8 in the service field is set to one (1).

4. The method of claim 1,
wherein based on the total bandwidth being set to 320 MHz, a value of bit B7 in the service field is set to one (1), and a value of bit B8 in the service field is set to zero (0),
wherein based on the total bandwidth being set to 640 MHz, a value of bit B7 in the service field is set to one (1), and a value of bit B8 in the service field is set to one (1).

5. The method of claim 4, wherein preamble puncturing is applied to the duplicated non-HT PPDU.

6. The method of claim 1,
wherein based on the total bandwidth being set to 640 MHz, values of bits B5 to B7 in the service field are set to zeros, a value of bit B8 in the service field is set to one (1), and bits B5 and B6 in the service field are bits B5 and B6 in the scrambling sequence applied to the data field.

7. The method of claim 1, wherein the duplicated non-HT PPDU is transmitted on a 6 GHz band.

8. An apparatus comprising:
a transceiver configured to transmit and/or receive a wireless signal; and
a processor configured to control the transceiver,
wherein the processor is further configured to:
configure a non-High Throughput (HT) Physical Protocol Data Unit (PPDU) comprising a preamble and a data field,
wherein the data field includes a service field, and the service field includes bits B0 to B15,
wherein the non-HT PPDU is duplicated in frequency domain,
wherein the service field comprises information related to a total bandwidth of the duplicated non-HT PPDU,
wherein a value of bit B8 in the service field relates to whether the total bandwidth exceeds 320 MHz; and
transmit the duplicated non-HT PPDU.

9. (canceled)

10. A method in a wireless local area network (WLAN) system, the method comprising:
receiving a Physical Protocol Data Unit (PPDU) comprising a non-High Throughput (HT) PPDU,
wherein the non-HT PPDU comprises a preamble and a data field,
wherein the data field includes a service field, and the service field includes bits B0 to B15,
wherein the non-HT PPDU is duplicated in frequency domain,
wherein the service field comprises information related to a total bandwidth of the duplicated non-HT PPDU,
wherein a value of bit B8 in the service field relates to whether the total bandwidth exceeds 320 MHz; and
obtaining information related to the total bandwidth.

11-12. (canceled)
